(19) United States
(12) Patent Application Publication
(10) Pub. No.: US 2014/0141853 A1
(43) Pub. Date: May 22, 2014

(54) SYSTEM AND METHOD FOR THE COMBINED PLAY OF WAGERING GAMES

(71) Applicant: Lamar Wilkinson, Pacheco, CA (US)

(72) Inventor: Lamar Wilkinson, Pacheco, CA (US)

(21) Appl. No.: 13/682,209

(22) Filed: Nov. 20, 2012

(51) Int. Cl. G07F 17/32; A63F 3/00

(52) U.S. Cl. CPC G07F 17/3293; A63F 3/00157; G07F 17/3272
USPC 463/11; 273/292

(57) ABSTRACT

The present disclosure contains a system and method for conducting a wagering game using a single deck of cards or other game pieces that combines the play of Pai Gow or double hand poker and Baccarat in two game parts. The wagering game includes hand evaluation rules for ranking the hands for each of the two game parts, with wagering settlement rules and specified payouts. The game is suited for play in any Las Vegas style casino or any casino operating under the gaming rules of California and may utilize a computer system or network to enhance or facilitate play of the wagering game.

### RELATED APPLICATION

The present application claims the benefit of priority under 35 USC 119 to U.S. Provisional Patent Application Ser. No. 61/613,816, filed on Mar. 21, 2012, entitled “Method and Apparatus for Pai Gow Poker and Baccarat Played Together” (Attorney Docket No. LODF.P0002P), which is hereby incorporated by reference in its entirety.

### BACKGROUND OF THE INVENTION

There are many casino card games, but usually only one game is played on a table at a time. This means that the house may only wager against or collect fees from players for one game at a time, and players may only wager on one hand or game at a time.

In Pai Gow Poker, also called double hand poker, each player receives 7 cards from which they form a 2 card and a 5 card hand. The bank, dealer, or person banking the game also receives 7 cards and forms a 2 card and a 5 card hand after the player hands are set. The bank's 2 card hand is compared to each player 2 card hand using poker hand rankings. The bank's 5 card hand is compared to each player 5 card hand using poker hand rankings Wagers are settled according to the results. For example, if either the bank or player wins the comparison between both the 2 card and 5 card hands, they win the player wager. If they split the hands and each wins one hand, then there is a push and the player wager is returned to the player.

One aspect of Pai Gow Poker using a single deck is that no more than 49 cards, or 7 seven card hands, may be dealt. There is also a “stub” consisting of at least 3 undealt cards, or more cards if jokers or other cards are added to the deck. In addition, the bank hand usually remains concealed until after the player hands are set, meaning that the 7 cards for the bank hand may be used for another purpose before they are exposed and set into the bank's Pai Gow Poker hand. So after the player Pai Gow hands are assigned, there are 10 or more cards that may be used to play another game or create a contest for players with additional wagers. If there are fewer than 6 player hands, there will be additional unused cards.

Baccarat also uses a limited number of cards. In Baccarat, there are only 2 two card hands, a banker hand and player hand. A player may wager on either the banker or player hand. Each Baccarat hand may receive one additional card in certain circumstances, known as a hit card. Because players do not have their own individual hand, and instead the banker and player hands serve all the participating players, at most 6 cards are needed to play Baccarat.

In Baccarat, the house or another player may act as the bank for each wager, that is the person or fund against which all wagers are made, regardless of whether the wager is on the banker hand or the player hand. So even though Baccarat has a “banker” hand, the person acting as the “bank” is wagering against one or more players, which players may wager on either the banker or player hand.

The players may bet on which hand has the higher value according to a hand ranking chart, bet on ties, or bet on other results or benchmarks. After placing the wagers, two cards are dealt for each hand. The hands are played modulo 10, that is, by comparing the last digit of the total card value. All hands will have a value of between 0 and 9. For example, if a hand has two cards consisting of a 9 and 7, which add up to 16, the hand value is a 6. Aces have a value of 1, and face cards and 10s have a value of 0, unless otherwise specified. Jokers, if used, may have a value assigned by the game rules. A value of 9 is the best hand possible. According to the game rules, the banker hand and player hand may each draw or “hit” one additional card whose numerical value is added to the first two cards.

The present wagering game is suited and for play in any casino. A participant may wager on either the player or banker hands. A participant may also wager on other outcomes, such as a tie, either or both hands being pairs, a hand achieving a 9 without a hit card, or other predetermined benchmarks. These additional or bonus wagers are paid according to fixed odds in a pay-table. The bonus bets could also be paid using a pari-mutuel formula, a parlay format or using a progressive payout. The casino takes the other side of the wagers, and collects all losing wagers, paying all winning wagers. But in some cases, in some casinos, players may take turns acting as the fund against which all other players wager, and the casino may take a fixed commission or fee.

### BRIEF DESCRIPTION OF THE DRAWINGS

The foregoing brief description, as well as further objects, features, and advantages of the present disclosure will be understood more completely from the following detailed description of a presently preferred, but nonetheless illustrative embodiment, with reference being had to the accompanying drawings, in which:

FIG. 1 is an example flow chart for conducting the wagering game with one or more players;

FIG. 2 is a schematic diagram of the electronic configuration of one embodiment of the gaming system of the present disclosure.

FIG. 3 illustrates an embodiment of a gaming table for use in conducting the wagering game.

### DETAILED DESCRIPTION

The present disclosure sets forth a system and method for conducting a wagering game using a single deck of cards or other game pieces that combines the play of Pai Gow or double hand poker and Baccarat in two game parts. The wagering game includes hand evaluation rules for ranking the hands for each of the two game parts, with wagering settlement rules and specified payouts.

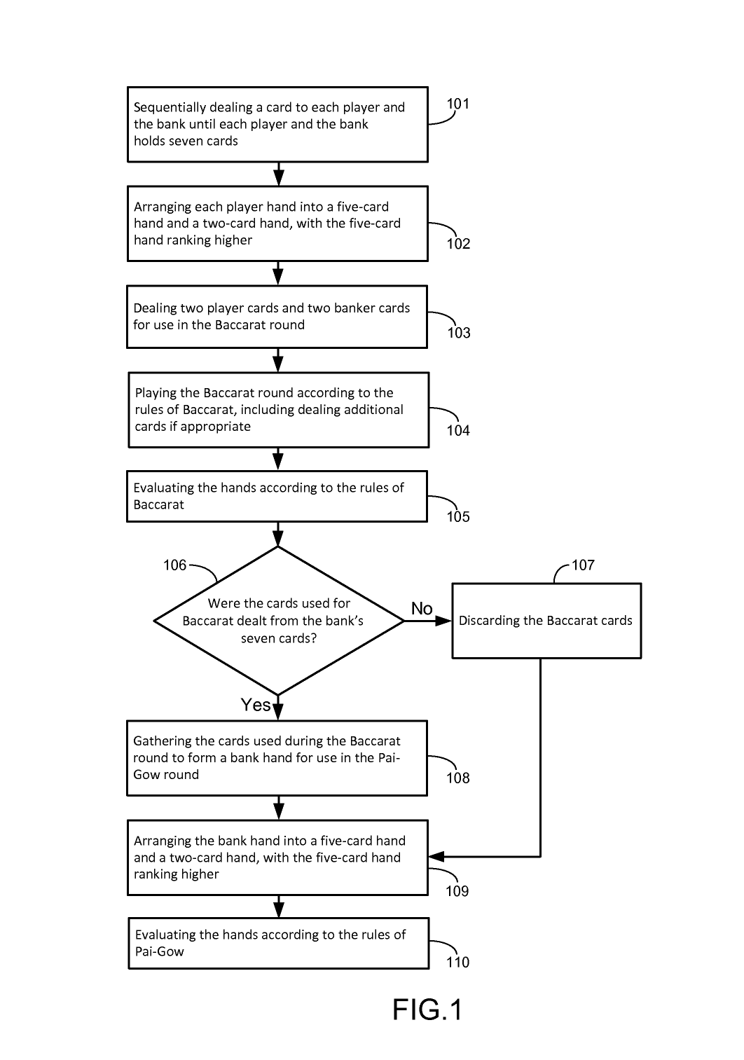

FIG. 1 shows a flowchart of an embodiment of the gaming procedures. Using a standard fifty-two (52) card deck, the bank deals the cards 101 into 7 card hands for double hand poker. Each player receives a double hand poker hand and the bank receives one double hand poker hand. Each player double hand poker hand is arranged into a two card hand and a five card hand 102. The bank hand remains concealed.

After the individual players set their double hand poker hands, the bank deals from the bank hand for double hand poker the cards to be used for Baccarat 103; two cards for the player hand for Baccarat and two cards for the banker hand for Baccarat. According to pre-determined rules, the Baccarat banker hand and player hand will stand or hit 104. The Baccarat hands and wagers will be evaluated and resolved according to hand evaluation rules 105.

After the Baccarat hands are completed, the bank will gather his cards 108 and set his two and five card hands using the cards from the original 7 card bank hand for double hand poker 109. The bank will compare the bank's double hand poker hands to each player's double hand poker hands resolving all wagers according to hand evaluation rules 110.

Alternatively, the cards used to form the banker and player hands for Baccarat may come from the remaining cards not used in dealing the Pai Gow hands 106. In this case, the Baccarat cards may be discarded after the Baccarat hands are evaluated 107.

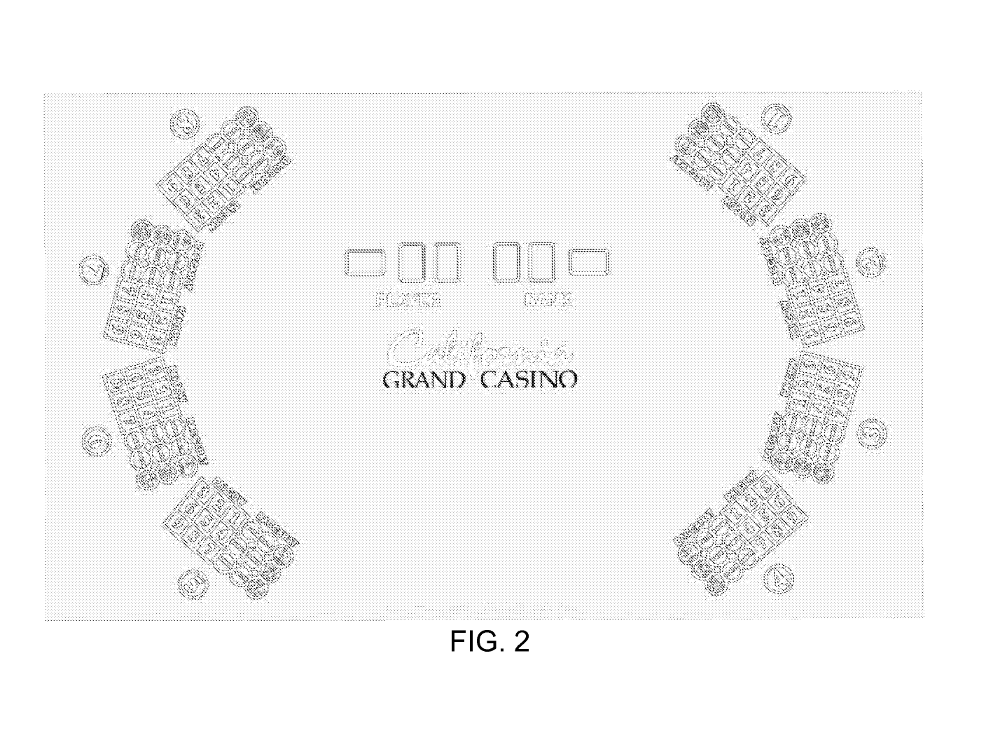

FIG. 2 illustrates an embodiment of a gaming table surface for use in the combined play of wagering games. The player Baccarat cards are placed on the player Baccarat region 301 and the banker Baccarat cards are placed on the banker Baccarat region 302. The casino or game designation region 303 is centrally located on the surface of the table below the player Baccarat region 301 and banker Baccarat region 302. Around the perimeter of the table surface are eight numbered player regions 306. Each player region contains a Pai Gow zone 304 for use during the Pai Gow round, and a Baccarat zone 305 for use during the Baccarat round.

In alternative embodiments, a player or person may wager on the outcome of any of the hands, or any combination of them, and the house will bank the bet. For example, a player may wager on the banker or player Baccarat hand with or without wagering on a Pai Gow hand. The player or participant may also wager on the Pai Gow hands without wagering on a Baccarat hand. The player wagers may also be made against other players. Players or participants may also wager on any hand or combination of hands achieving a certain pre-determined rank or outcome. For example, a player may wager on either or both Baccarat hands being pairs, or there being a tie between the banker and player hands. Certain wagers may win back the amount wagered, while others are paid odds according to a pay table, based on a prize pool, progressive prize or pari-mutuel payout. Additionally, players or participants may place a parlay wager which links together two or more individual wagers.

In alternative embodiments, the deck may have one or more added cards, including one or more jokers. The game rules may assign a value to the joker or make the joker a wild card. The value of the joker may also be different for the double hand poker game than for the Baccarat game.

In alternative embodiments, the cards that are not dealt or used for double hand poker, called the stub, may be used for the Baccarat hands.

In alternative embodiments, the Baccarat hands are settled or created after the double hand poker hands are resolved.

In alternative embodiments, the cards used for the banker and player baccarat hands are dealt in a specified order.

In alternative embodiments, for any part of the game, dice, tiles or other gaming indicia are substituted for playing cards.

In alternative embodiments, one or more players share one double hand poker player hand.

In alternative embodiments, some or all of the cards are concealed from other players.

In alternative embodiments, there are one or more players.

In alternative embodiments, there are one or more players who are not physically present at the table.

In alternative embodiments, the evaluation of the Baccarat hands is used to break a tie resulting from the evaluation of the Pai Gow hands.

In alternative embodiments, at least seven Pai Gow hands are dealt regardless of the number of players participating.

In alternative embodiments, the Pai Gow hands are evaluated before the Baccarat hands are evaluated.

In alternative embodiments, if the first or second player hand beats the corresponding bank hand and the first or second bank hand beats the corresponding player hand, the game results in a push and all or a portion of the player's wager is returned to the player.

In alternative embodiments, if the first or second player hand beats the corresponding bank hand, the first or second bank hand beats the corresponding player hand, and the player Baccarat hand beats the banker Baccarat hand, an award is given to the player based on the amount of the player's wager.

In alternative embodiments, if the player makes a separate wager on the Baccarat hand, and if the player Baccarat hand beats the banker Baccarat hand, an award is given to the player based on the amount of the player's separate wager.

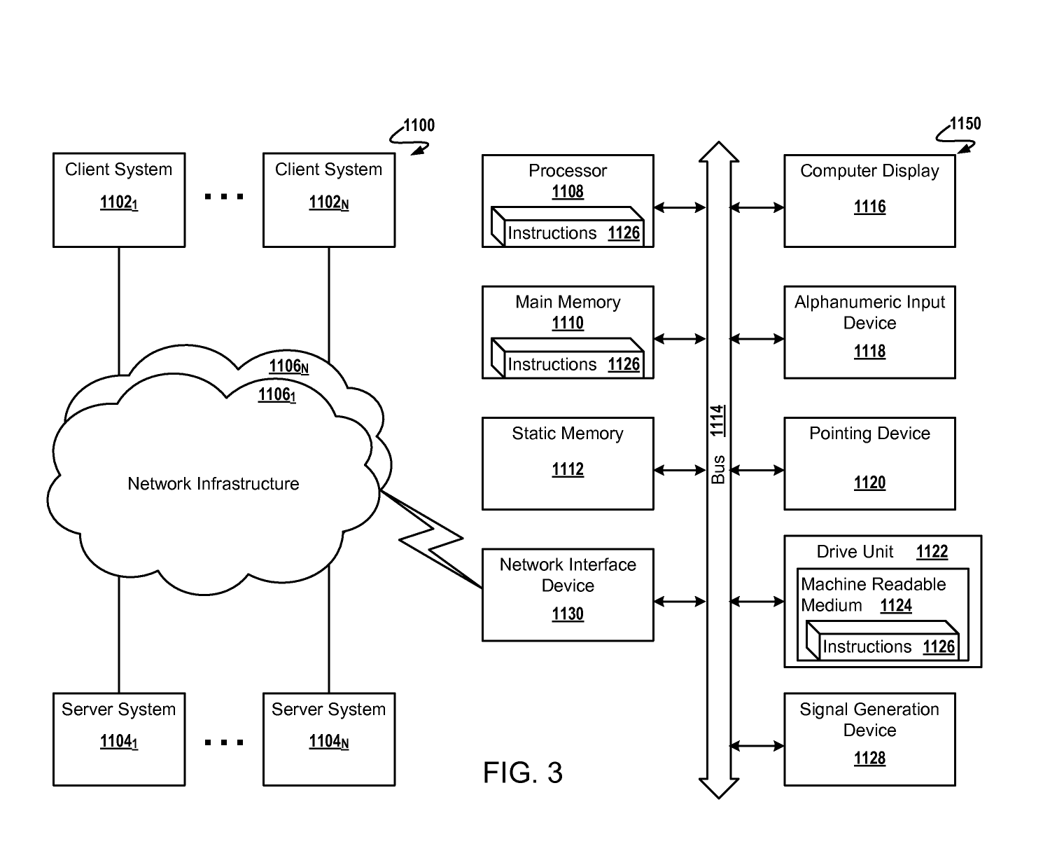

In alternative embodiments, all or part of the game is conducted using at least one computer system. FIG. 3 is a block diagram 1100 of a computer system for implementing embodiments of the platform. The computer system includes nodes for client computer systems 11021 through 1102N, nodes for server computer systems 11041 through 1104N, and nodes for network infrastructure 11061 through 1106N, any of which nodes may comprise a machine (e.g. computer 1150) within which a set of instructions for causing the machine to perform any one of the techniques discussed above may be executed. The embodiment shown is purely exemplary, and might be implemented in the context of one or more of the figures herein.

Any node of the network may comprise a general-purpose processor, a digital signal processor (DSP), an application specific integrated circuit (ASIC), a field programmable gate array (FPGA) or other programmable logic device, a discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems (including a processor and memory), a massively parallel computer system, and/or a cloud computer system.

The computer system (e.g. computer 1150) includes a processor 1108 (e.g. a processor core, a microprocessor, a computing device, etc.), a main memory (e.g. computer memory 1110), and a static memory 1112, which communicate with each other via a system bus 1114. The computer 1150 may further include a display unit (e.g. computer display 1116) that may comprise a touch-screen, or a liquid crystal display (LCD), or a light emitting diode (LED) display, or a cathode ray tube (CRT). As shown, the computer system also includes a human input/output (I/O) device 1118 (e.g. a keyboard, an alphanumeric keypad, etc.), a pointing device 1120 (e.g. a mouse, a touch screen, etc.), a drive unit 1122 (e.g. a disk drive unit, a CD/DVD drive, a tangible computer readable removable media drive, an SSD storage device, etc.), a signal generation device 1128 (e.g. a speaker, an audio output, etc.), and a network interface device 1130 (e.g. an Ethernet interface, a wired network interface, a wireless network interface, a propagated signal interface, etc.).

The drive unit 1122 includes a machine-readable medium 1124 on which is stored a set of instructions (i.e. software, firmware, middleware, etc.) 1126 embodying any one, or all, of the methodologies described above. The set of instructions 1126 is also shown to reside, completely or at least partially, within the main memory and/or within the processor 1108.

The set of instructions 1126 may further be transmitted or received via the network interface device 1130 over the system bus 1114.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing non-transitory information in a form readable by a machine (e.g. a computer). For example, a machine-readable medium includes read-only memory (ROM); random access memory (RAM); magnetic disk storage media; optical storage media; flash memory devices; and electrical, optical or acoustical or any other type of media suitable for storing non-transitory information.

Although the present disclosure has been described in terms of specific exemplary embodiments, it will be appreciated that various modifications and alterations might be made by those skilled in the art without departing from the spirit and scope of the invention. While many embodiments have been described, it is to be understood that different embodiments may be combined in various ways and are not considered mutually exclusive.

What is claimed is:

1. A method for at least one player and at least one bank to play a card game with a plurality of cards, the card game including a Baccarat round and a Pai Gow round, the method comprising:
dealing cards in any order until the bank and each player hold seven cards used for Pai Gow Poker;
dividing each player's cards into a five-card hand and a two-card hand to form each player's Pai Gow hand, such that the five-card hand ranks higher than the two-card hand according to the rules of Pai Gow;
dealing two cards to form the player Baccarat hand and two cards to form the banker Baccarat hand;
playing the Baccarat round in accordance with rules of Baccarat, including dealing additional cards if necessary and evaluating the hands according to the rules of Baccarat;
dividing the bank's Pai Gow cards into a five-card hand and a two-card hand for Pai Gow, such that the five-card hand ranks higher than the two-card hand according to the rules of Pai Gow; and
playing the Pai Gow round in accordance with rules of Pai Gow, including evaluating each Pai Gow hand according to the rules of Pai Gow.

2. The method of claim 1, wherein a player or person may wager on the outcome of any of the hands, or any combination of them.

3. The method of claim 1, wherein one or more cards are used in addition to the standard deck of cards, including one or more jokers.

4. The method of claim 1, wherein only one standard deck of cards is used to play the game.

5. The method of claim 1, wherein the cards that are not dealt or used for the Pai Gow round are used to form the Baccarat hands.

6. The method of claim 1, wherein the Baccarat hands are created or resolved after the double hand poker hands are resolved.

7. The method of claim 1, wherein the Pai Gow hands are created or resolved after the Baccarat hands are resolved.

8. The method of claim 1, wherein the cards used for the banker and player baccarat hands are dealt in a specified order.

9. The method of claim 1, wherein for any part of the game dice, tiles or other gaming indicia are substituted for playing cards.

10. The method of claim 1, wherein some or all of the cards are concealed.

11. The method of claim 1, wherein some or all of the player wagers are made against other players.

12. The method of claim 1, wherein a player or person may wager on any hand or combination of hands achieving a certain pre-determined rank or outcome.

13. The method of claim 1, wherein a player or person may wager on any predetermined benchmark or outcome within fixed pay out odds, a pari-mutuel payout, or from a progressive fund.

14. The method of claim 1, wherein one or more players share one double hand poker player hand.

15. The method of claim 1, wherein there are one or more players.

16. The method of claim 1, wherein there are one or more players who are not physically present at the table.

17. The method of claim 1, wherein the play of the game is conducted all or in part electronically using a computer.

18. The method of claim 1, wherein the cards from the bank's seven-card Pai Gow hand are used to form the Baccarat hands.

19. The method of claim 1, wherein the evaluation of the Baccarat hands is used to break a tie resulting from the evaluation of the Pai Gow hands.

20. The method of claim 1, wherein at least seven Pai Gow hands are dealt regardless of the number of players participating.

21. The method of claim 1, wherein a player or person may place a parlay wager which links together two or more individual wagers.

22. The method of claim 1, wherein multiple players connected electronically over a computer or telephone network may participate in the game.

23. The method of claim 1, wherein the Pai Gow hands are evaluated before the Baccarat hands.

24. A gaming system comprising:
at least one input device;
at least one processor;
at least one display device; and
at least one memory device storing a plurality of instructions which when executed by the at least one processor, cause the at least one processor to operate with the at least one display device and the at least one input device to, for a play of a game:
(a) enable a wager to be placed,
(b) deal at least seven bank cards and at least seven player cards for Pai Gow Poker,
(c) receive at least one input to form a five-card player hand and a two-card player hand, a rank of the two-card player hand not being greater than a rank of the five-card player hand,
(d) deal two player cards to form a player Baccarat hand and two banker cards to form a banker Baccarat hand,
(e) deal an additional banker card or an additional player card, or both, based on the rules of Baccarat,
(f) evaluate the Baccarat hands to determine winners and losers,
(g) form a five-card Pai Gow bank hand and a two-card Pai Gow bank hand, a rank of the two-card bank hand not being greater than a rank of the five-card bank hand,
(h) determine if the five-card player hand beats the five-card bank hand,
(i) determine if the two-card player hand beats the two-card bank hand,
(j) if both the player hands beat the corresponding bank hands, award the player based on the amount of the player's wager.

25. A non-transitory computer readable medium including a plurality of instructions which, when executed by at least one processor, cause the at least one processor to, for each of the at least one player, for the play of a game by said player:
sequentially deal a first card to each player and a first card to a bank until each player and the bank hold seven cards for Pai Gow Poker;
enable each player to divide their cards into a five-card hand and a two-card hand to form a player Pai Gow hand, such that the five-card hand ranks higher than the two-card hand according to the rules of Pai Gow;
deal two cards to form a player Baccarat hand and two cards to from a banker Baccarat hand;
deal additional cards, if appropriate, according to the rules of Baccarat;
evaluate the hands according to the rules of Baccarat;
divide the bank's cards into a five-card hand and a two-card hand to form a bank's Pai Gow hand, such that the five-card hand ranks higher than the two-card hand according to the rules of Pai Gow; and
evaluate each Pai Gow hand according to the rules of Pai Gow.
